(19) United States
(12) Patent Application Publication
(10) Pub. No.: US 2022/0061377 A1
(43) Pub. Date: Mar. 3, 2022

(54) Embossed Tipping Paper and Method of Manufacturing Smoking Article with Embossed Tipping Paper

(71) Applicant: JT International S.A., Geneva (CH)

(72) Inventors: Hiroyoshi Ono, Tokyo (JP); Toshihiro Nakahama, Tokyo (JP)

(73) Assignee: JT International S.A., Geneva (CH)

(21) Appl. No.: 17/415,479

(22) PCT Filed: Dec. 6, 2019
(86) PCT No.: PCT/EP2019/084064

§ 371 Date: Jun. 17, 2021

(30) Foreign Application Priority Data
Dec. 21, 2018 (EP) 18215156.3

(51) Int. Cl. A24C 5/56; A24D 1/02; A24C 5/58; A24C 5/00; A24D 3/04

(52) U.S. Cl. CPC A24C 5/56; A24D 1/027; A24D 3/043; A24C 5/007; A24C 5/586

(57) ABSTRACT

An embossed tipping paper includes a relief pattern region having a patterned embossing structure formed in the depth of the material of the tipping paper. The embossed tipping paper further includes at least one plain region adjacent to the relief pattern region, the at least one plain region not having an embossing structure formed in the depth of the material of the tipping paper. A sequence of ventilation holes is formed in the at least one plain region. The embossed tipping paper has a substantially rectangular shape and the at least one plain region forms a band of fixed width running between two parallel edges of the substantially rectangular shape.

### CROSS-REFERENCE TO RELATED APPLICATIONS

The present application is a national phase entry under 35 U.S.C. § 371 of International Application No. PCT/EP2019/084064, filed Dec. 6, 2019, published in English, which claims priority to European Application No. 18215156.3 filed Dec. 21, 2018, the disclosures of which are incorporated herein by reference.

### BACKGROUND OF THE INVENTION

The present invention pertains to a method of manufacturing a smoking article with embossed tipping paper, to smoking articles such as cigarettes, double-cigarettes, disposable tobacco sticks and similar, to embossing rollers used in manufacturing embossed tipping paper for smoking articles and a manufacturing system for manufacturing smoking articles with embossed tipping paper.

For smoking articles containing herbal smoking material such as tobacco, envelope papers are wrapped in one or more layers around the various components of the smoking articles to mechanically hold them in place. Such envelope papers are usually made of a special paper grade for industrial production obtained from chemical pulp as paper of high quality, ensuring inter alia appropriate tensile and tearing strength, low air permeability, enough control of burning speed, enough opacity, optimal runnability and good edge quality.

The envelope paper used to establish a mechanical connection between the plug wrap paper wrapped around the filter material and the cigarette tissue is commonly referred to as tipping paper—an envelope paper of higher basis weight than the plug wrap paper. In order to enhance the visual and tactile appearance of smoking articles overall, embossing techniques such as printing or stamping may be used to set a relief or counter-relief pattern into the tipping paper. Embossed patterns give the tipping paper a unique and aesthetically pleasing visual appearance and a comfortable feel in a user's hands or at a user's lips, thereby increasing the perceived quality of the smoking article. For example, document CN 201 339 146 Y discloses embossed tipping paper.

When using embossed tipping paper to manufacture smoking articles, it is desirable for the relief pattern formed on the tipping paper not to interfere with or negatively impact the performance of subsequent manufacturing stages. Document EP 0 536 407 A1, for example, discloses a tipping paper used for a cigarette with which the variation in the amount of air flow from a vented filter can be reduced through provision of ventilation holes in the embossed region of the tipping paper only.

However, improved solutions for the manufacturing of embossed tipping papers for smoking articles are needed.

### BRIEF SUMMARY OF THE INVENTION

Therefore, according to an aspect of the present invention an embossed tipping paper includes a relief pattern region having a patterned embossing structure formed in the depth of the material of the tipping paper. The embossed tipping paper further includes at least one plain region adjacent to the relief pattern region, the at least one plain region not having an embossing structure formed in the depth of the material of the tipping paper. A sequence, i.e. a plurality, of ventilation holes is formed in the at least one plain region. The embossed tipping paper has a substantially rectangular shape and the at least one plain region forms a band of fixed width running between two parallel edges of the substantially rectangular shape.

According to a further aspect of the invention, a method for manufacturing smoking articles with embossed tipping paper involves the steps of forming a patterned embossing structure in the depth of the material of the tipping paper, omitting at least one plain region adjacent to the relief pattern region during formation of the patterned embossing structure in the depth of the material of the tipping paper, and forming a sequence of ventilation holes in the at least one plain region of the tipping paper. This way, the tipping paper includes a relief pattern region with a patterned embossing structure and at least one plain region not having a patterned embossing structure. The embossed tipping paper has a substantially rectangular shape and the at least one plain region forms a band of fixed width running between two parallel edges of the substantially rectangular shape.

A further aspect of the invention pertains to an embossing roller used for embossing tipping paper for smoking articles, the embossing roller including an engraving pattern on the roller surface, the engraving pattern configured to form a relief pattern region having a patterned embossing structure in the depth of the material of the tipping paper, and at least one plain area on the roller surface adjacent to the engraving pattern, the at least one plain area configured to form at least one plain region adjacent to the relief pattern region, the at least one plain region not having an embossing structure formed in the depth of the material of the tipping paper. The at least one plain area forms a band of fixed width running through the engraving pattern in parallel to the circumference of the embossing roller.

According to a further aspect of the invention, a manufacturing system for manufacturing smoking articles with embossed tipping paper includes an embossing roller in line with an aspect of the invention.

Yet another aspect of the invention pertains to a smoking article having embossed tipping paper according to one of the aspects of the invention. The smoking article may in particular be one of a cigarette, a double cigarette, a cigarette cartridge, a disposable tobacco stick and a double disposable tobacco stick for use in heat-not-burn products. The embossed tipping paper of the smoking article is wrapped around a filter plug of the smoking article. The smoking articles may further comprise a plug wrap, typically made from porous or non-porous paper, that is wrapped around the filter plug beneath the embossed tipping paper. The embossed tipping paper may in particular have a higher basis weight than the paper of such a plug wrap.

One idea of the invention is to selectively spare out certain regions of a tipping paper for smoking articles during an embossing step so that not the whole tipping paper is covered with a relief or counter-relief pattern. Such only partially embossed tipping papers may present advantageous properties in subsequent processing steps for the smoking articles, for example separating smoking articles in the region of the filter plugs or forming ventilation holes in the tipping paper for ventilating the filter plugs.

Specifically, the dedicatedly spared out regions, i.e. the regions of the tipping paper which are not embossed with a relief or counter-relief pattern, may allow for more precise processing of the smoking articles in those regions. For example, separating smoking articles in unembossed regions of the filter plugs may avoid the appearance of hairy paper pulp that would otherwise occur due to the uneven distribution of tipping paper thickness when the tipping paper would be embossed in the area where the separation cut is introduced in the filter plug. In other examples, forming ventilation holes by means of laser irradiation in the tipping paper may be made with higher precision since keeping the focus of the laser beam in the plane of the tipping paper is easier when the tipping taper does not have dimples, grooves or rugged surface areas as it would be the case if the tipping paper would be embossed in the region where ventilation holes are to be formed by laser-cutting.

According to an embodiment of the embossed tipping paper, the fixed width of the at least one plain region may be at least 1 mm, particularly at least 2 mm. This ensures enough space between embossed areas for operations being performed on the smoking article after the embossed tipping paper is wrapped around a filter plug of the smoking article.

According to another embodiment of the embossed tipping paper, the embossed tipping paper may comprise at least two plain regions adjacent to the relief pattern region, the at least two plain regions not having an embossing structure formed in the depth of the material of the tipping paper and running in parallel to each other between two parallel edges of the substantially rectangular shape of the embossed tipping paper. In some of those embodiments, a first of the at least two plain regions may be formed substantially at a side edge of the substantially rectangular shape of the embossed tipping paper. In alternative embodiments, both of the at least two plain regions may be formed substantially in the middle of the substantially rectangular shape of the embossed tipping paper. In some variations of the embodiments, it may be possible that a first of the at least two plain regions is formed substantially at a side edge of the substantially rectangular shape of the embossed tipping paper, and a second of the at least two plain regions is formed substantially in the middle of the substantially rectangular shape of the embossed tipping paper.

According to another embodiment of the embossed tipping paper, the patterned embossing structure may be formed to a depth of more than 45 μm of the material of the tipping paper.

The embossed tipping paper comprises a sequence of ventilation holes formed in the at least one plain region of the tipping paper. In some embodiments thereof, the sequence of ventilation holes may be a linear arrangement of a series of ventilation holes running in parallel to the band of fixed width in the middle of the at least one plain region. Such ventilation holes may be useful for controlling TNCO parameters of the smoking articles. Advantageously, forming the sequence of ventilation holes in a plain, i.e. non-embossed region of the embossed tipping paper allows better control of the cutting precision. For example, if laser cutting is used to form the ventilation holes, the laser beam may be focused more precisely on the surface of the tipping paper, if the tipping paper does not have a relief pattern structure in the area of the laser beam.

The method for manufacturing smoking articles with embossed tipping paper comprises a step of forming a sequence of ventilation holes in the at least one plain region of the tipping paper, for example using laser cutting. Such a sequence of ventilation holes may in some embodiments thereof be formed as a linear arrangement of a series of ventilation holes running in parallel to the band of fixed width in the middle of the at least one plain region.

According to another embodiment of the method for manufacturing smoking articles with embossed tipping paper, the method may further comprise a step of separating two portions of the embossed tipping paper along the middle line of the band forming the at least one plain region. This may in particular be useful for double cigarettes which are separated into single cigarettes in the middle of the filter plug. Cutting along a plain region, i.e. a non-embossed region of the tipping paper yields a cleaner cut edge than cutting along an embossed region.

### BRIEF DESCRIPTION OF THE DRAWINGS

The invention will be explained in greater detail with reference to exemplary embodiments depicted in the drawings in which:

FIG. 1 schematically illustrates a perspective view of a smoking article with embossed tipping paper according to an embodiment of the invention;

FIG. 2 schematically illustrates a top view on an embossed tipping paper according to a further embodiment of the invention;

FIG. 3 schematically illustrates a top view on an embossed tipping paper according to yet another embodiment of the invention;

FIG. 4 schematically illustrates details of a manufacturing system for smoking articles according to another embodiment of the invention;

FIG. 5 schematically illustrates a perspective view on part of a manufacturing system for smoking articles according to another embodiment of the invention;

FIG. 6 schematically illustrates a top view on an embossed tipping paper according to a further embodiment of the invention;

FIG. 7 schematically illustrates a top view on an embossed tipping paper according to yet another embodiment of the invention;

FIG. 8 schematically illustrates a top view on an embossed tipping paper according to yet another embodiment of the invention;

FIG. 9 schematically illustrates a flow diagram of a method for manufacturing a smoking article with embossed tipping paper according to another embodiment of the invention; and

FIG. 10 schematically illustrates a simplified perspective view of an embossing roller as part of a manufacturing system for smoking articles according to another embodiment of the invention.

### DETAILED DESCRIPTION

Although specific embodiments have been illustrated and described herein, it will be appreciated by those of ordinary skill in the art that a variety of alternate and/or equivalent implementations may be substituted for the specific embodiments shown and described without departing from the scope of the present invention.

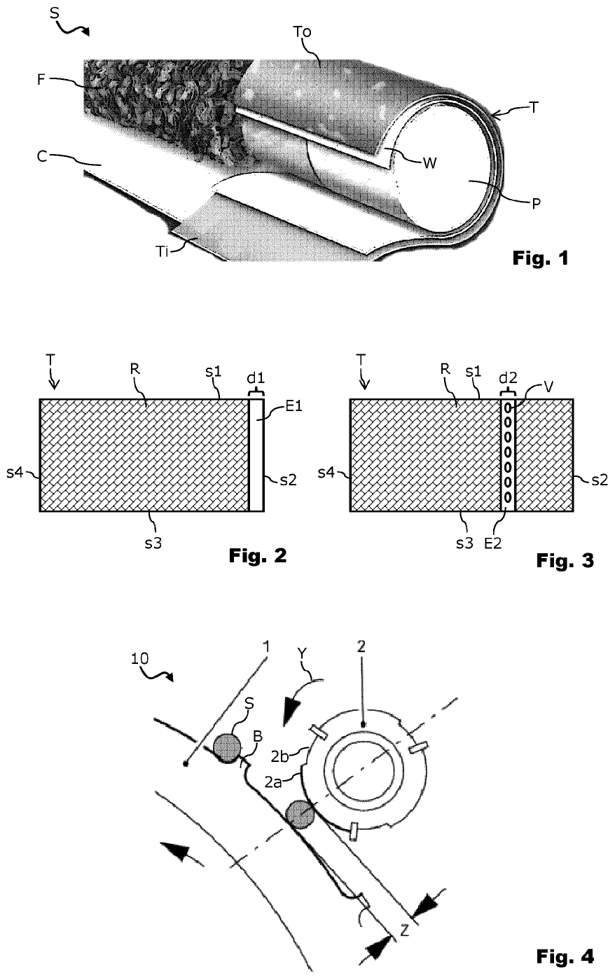

FIG. 1 illustrates a perspective view of a smoking article S. The smoking article S is specifically depicted as a cigarette with a filter, however, it should be apparent to the skilled person that other forms of smoking articles S such as double cigarettes, cigarillos, cigarette cartridges, disposable tobacco sticks or double disposable tobacco sticks for use in a heat-not-burn product are equally covered by the present disclosure. Particularly, any explanations for the tipping paper and the filter plug exemplarily illustrated in FIG. 1 and further in conjunction with FIGS. 2 to 9 are equally applicable for tipping papers and filter plugs of such other forms of smoking articles as well.

The smoking article S is shown in FIG. 1 as a filter cigarette. The filter cigarette includes a tobacco rod F and a filter plug P located at a mouth end of the smoking article S. The tobacco rod F may for example contain a blend of tobacco which is encapsulated in a paper sleeve C. The filter plug P may for example be formed of a rod-shaped cellulose acetate fibre or tow and may be overwrapped by a plug wrap W made from porous paper. The tobacco rod F may be attached to the filter plug P by a tipping paper T. As depicted in FIG. 1 in the partially dismantled state, the tipping paper T generally has an outer surface To forming an outer surface of the smoking article S and an inner surface Ti surrounding the plug wrap W. The material of the tipping paper T may generally have a higher basis weight than the paper of the plug wrap W and may for example be white paper or cork paper having a basis weight of 50 gsm, 55 gsm, 60 gsm or 80 gsm.

The tipping paper T used for overwrapping the plug wrap W and attaching the tobacco rod F to the filter plug P may be partially embossed. Possible variations for the embossing patterns formed on the tipping paper T are exemplarily shown in FIGS. 2, 3, 6, 7 and 8. It should be apparent that combinations of different features and variations as depicted in FIGS. 2, 3, 6, 7 and 8 may be used in conjunction with each other in order to derive other configurations for embossing patterns formed on the tipping paper T not explicitly shown in the drawings.

The tipping paper T depicted in FIGS. 2, 3, 6, 7 and 8 generally has a substantially rectangular shape. Without loss of generality, the tipping paper T has two horizontal edges s1 and s3 parallel to each other and two vertical edges s2 and s4 parallel to each other. The majority of the tipping paper T is covered with a relief pattern region R that has a patterned embossing structure formed in the depth of the material of the tipping paper T. The pattern of the embossing structure may include any regularly repeated arrangement of repeated lines, geometric shapes or colours on the surface of the tipping paper T. For example, the pattern of the embossing structure may include repeating geometric shapes such as diamonds, squares, wavy lines, slanted lines or similar. Alternatively, or additionally, the pattern of the embossing structure may also form specific signs such as numbers or letters interspersed or distributed uniformly or evenly over the surface of the embossed part of the tipping paper. That way, the pattern of the embossing structure may form logos or letterings for the user to decipher on the tipping paper.

The embossing structure may in particular have sunk or counter-sunk portions in the depth of the material of the tipping paper that follow the respective repeating arrangement of shapes and lines. The patterned embossing structure may be formed to a depth of more than 45 μm of the material of the tipping paper T, i.e. the difference in height between a depressed area and a heightened area of the patterned embossing structure may be more than 45 μm, for example up to 90 μm.

The relief pattern region R itself may be bordering directly on one or more edges of the substantially rectangular shape, such as for example the side edges s1, s3 and s4. The relief pattern region R is formed that is does not cover the whole surface of the tipping paper T. Instead, at least one plain region is formed adjacent to the relief pattern region R. The at least one plain region does not have an embossing structure formed in the depth of the material of the tipping paper T, i.e. the material of the tipping paper has not been subject to an embossing operation in those plain regions.

FIGS. 2, 3, 6, 7 and 8 show various examples for possible configurations of the plain regions which are denoted with reference numerals E1, E2 and E3 in the drawings. The plain regions E1, E2 and E3 generally form a band of fixed width running between two parallel edges s1, s3 of the substantially rectangular shape. The fixed width is denoted with reference numerals D1, d1, d2 and d3, respectively, in the drawings. For example, the fixed width of the plain regions E1, E2 and E3 may be at least 1 mm such as for the fixed widths d1, d2 and d3 in FIGS. 2, 3, 6 and 7. In some configurations, the fixed width of the plain regions E1, E2 and E3 may be at least 2 mm, such as for example the fixed width D1 of the band E1 in FIG. 8. The fixed width may be chosen according to expected typical processing dimensions in processing steps to be performed on the embossed tipping paper T after the embossed tipping paper T has been wrapped around a filter plug P of a smoking article S. For example, the fixed width D1 of 2 mm may be chosen for n embossed tipping paper T for a double cigarette in order to provide enough space for cutting in the middle of the band of the plain region.

As shown in FIG. 2, a plain region E1 may be formed substantially at a side edge s2 of the substantially rectangular shape of the embossed tipping paper T. As shown in FIG. 6, another plain region E2 may be formed in addition to the plain region E1 substantially in the middle of the substantially rectangular shape of the embossed tipping paper T. The two plain regions E1 and E2 run in parallel to each other between two parallel edges s1, s3 of the substantially rectangular shape of the embossed tipping paper T.

As illustrated in FIG. 3, it may be possible to only provide a plain region E2 of fixed width d2 substantially in the middle of the substantially rectangular shape of the embossed tipping paper T. The band of the plain region E2 is placed where a sequence of ventilation holes V is to be formed in the tipping paper T. The sequence of ventilation holes V may for example be a linear arrangement of a series of ventilation holes V running in parallel to the band of fixed width in the middle of the plain region E2. The fixed width d2 may in this configuration be chosen to guarantee sufficient separation between the edges of the relief pattern region R and the edges of the ventilation holes V. The ventilation holes V may for example have a typical diameter of 0.5 mm or less.

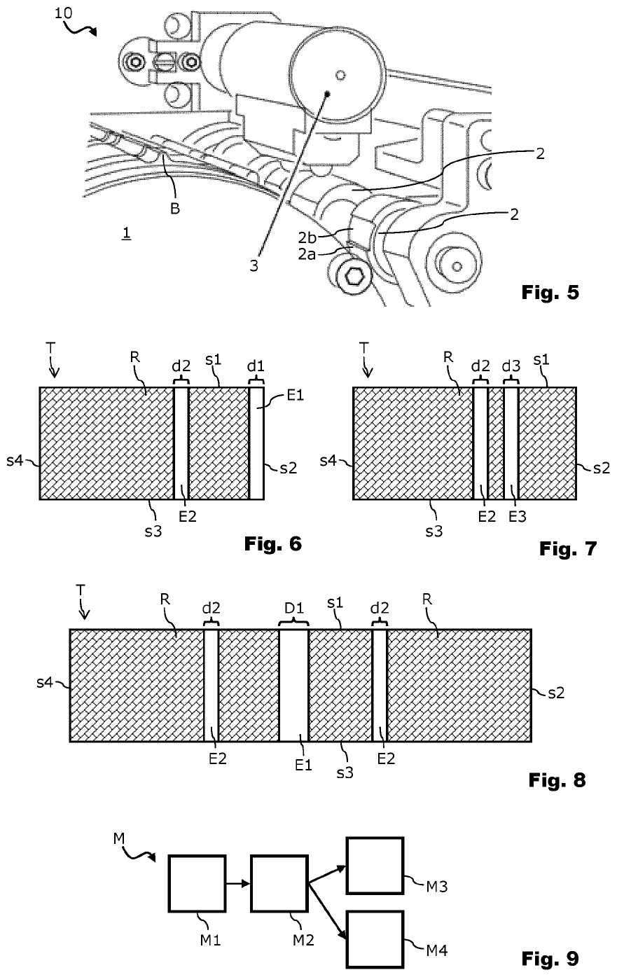

As illustrated in FIG. 7, two bands of plain regions E2 and E3 with fixed widths d2 and d3 may be formed substantially in the middle of the rectangular shape of the tipping paper T. The fixed widths d2 and d3 may be equal or may differ from each other. The bands of plain regions E2 and E3 may generally run in parallel to each other and may be spaced apart by a fixed distance.

Of course, and as shown in conjunction with FIG. 8, more than two bands of plain regions E1 and E2 may be formed in the tipping paper T as appropriate and necessary. The tipping paper T in the example of FIG. 8 may for example be used for wrapping a filter plug of a double cigarette or a double disposable tobacco stick.

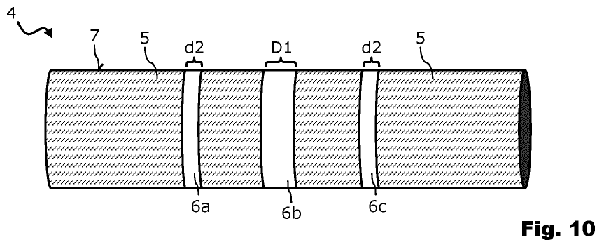

A possible implementation of an embossing roller 4 that may be used to emboss tipping paper in a manufacturing system for smoking articles is exemplarily depicted in FIG. 10. The embossing roller 4 of FIG. 10 is configured with an engraving pattern 5 on the roller surface 7, the engraving pattern 5 being configured to form a relief pattern region R having a patterned embossing structure in the depth of the material of the tipping paper T, in line with the configuration of FIG. 8. To that end, the embossing roller 4 additionally has one or more plain areas 6a, 6b, 6c formed on the roller surface 7 adjacent to the engraving pattern 5. The plain area(s) 6a, 6b, 6c is/are configured to form one or more plain regions on a tipping paper processed with the embossing roller 4, the plain regions lying adjacent to the relief pattern region R. Those plain regions then do not have an embossing structure formed in the depth of the material of the tipping paper T.

For example, first and second plain areas 6a, 6c may be implemented off-centre of the middle line around the circumference of the embossing roller 4. Those first and second plain areas 6a, 6c may be used to spare out plain regions E2 as shown in FIG. 8. Other plain areas such as a third plain area 6b on the roller surface 7 may be implemented substantially in the centre of the embossing roller 4. Tipping paper T embossed using the embossing roller 4 will then have a plain region E1 in the middle of the tipping paper T, i.e. about halfway between the edges s2 and s4 of the rectangularly shaped tipping paper T.

The axial length of the embossing roller 4 may be about the same as the desired length of the horizontal side edges s2 and s4 of tipping paper T to be embossed. The circumference of the embossing roller 4 may have the same value as the desired length of the vertical side edges s1 and s3 of tipping paper T to be embossed.

The embossing roller 4 may be provided with a plain counter-roller in a manufacturing system for smoking articles. An endless supply of tipping paper base web having a breadth corresponding to the length of the horizontal side edges s2 and s4 may be wound up on a bobbin. The base web may be provided from the bobbin to an assembly of tension, guidance and registering rollers in order to feed the tipping paper base web between an embossing roller 4 and the corresponding counter-roller. The embossing roller then engraves the relief pattern regions in an endless fashion on the tipping paper base web. After the engraving operation, the tipping paper base web is cut in intervals perpendicular to the direction of travel of the base web in order to separate the base web into rectangularly shaped pieces of partially embossed tipping paper T. The intervals may correspond to a desired breadth of the embossed tipping paper T, i.e. the length of the vertical side edges s2 and s4.

Due to the engraving pattern 5 being interrupted by one or more bands of plain areas 6a, 6b, 6c on the roller surface 7 of the embossing roller 4, the resulting pieces of partially embossed tipping paper T will substantially have the appearance as depicted in FIG. 2, 3, 6, 7 or 8, with the one or more plain regions forming parallel bands running from the top to the bottom of the rectangularly shaped tipping paper T. Those bands each have a fixed width corresponding to the fixed width of the bands of plain areas 6a, 6b, 6c running through the engraving pattern 5 in parallel to the circumference of the embossing roller 4.

The partially embossed tipping paper T that has run through the manufacturing system using the embossing roller 4 and a corresponding counter-roller may then be used in subsequent stages of the manufacturing system to wrap filter plugs P, for example filter plugs of double cigarettes or double disposable tobacco sticks.

While there is a specific example with three plain areas 6a, 6b and 6c shown in FIG. 10 it should be clear that corresponding embossing rollers with a different number and/or arrangement of plain areas may be implemented in order to obtain embossed tipping papers T in line with the exemplary configurations of FIGS. 2, 3, 6 and 7.

FIGS. 4 and 5 show schematic details of a manufacturing system 10 for manufacturing smoking articles S including partially embossed tipping paper T as explained in conjunction with FIGS. 1, 2, 3, 6, 7 and 8. The manufacturing system 10 of FIGS. 4 and 5 may in particular include a processing stage with an embossing roller 4 in line with FIG. 10 prior to the processing stages exemplarily illustrated in FIGS. 4 and 5. The manufacturing system 10 generally includes a perforation drum 1 having extended grooves between transfer teeth B where smoking articles S are transported in a drum movement direction (indicated by the arrow underneath the drum 1 in FIG. 4). A tension roller 2 rotates in the counter-direction Y and rolls the smoking articles S around their longitudinal axis as the perforation drum moves past the tension roller 2. To that end, the tension roller 2 is spaced apart from the surface of the perforation drum 1 by a distance Z that is slightly smaller than the diameter of the generally cylindrical smoking articles S. A camming surface 2a of the tension roller 2 pushes down on the smoking article S, making it rotate around its own longitudinal axis as the perforation drum 1 moves past the tension roller 2. The camming surface 2a is offset by a release surface 2b of the tension roller 2 in order to let go of the smoking article S after rotation.

The perforation drum 1 and one or more tension rollers 2 may be used in the system of FIG. 5 where the rotation of the smoking articles S is used to form a sequence of ventilation holes around the circumference of their filter. The smoking articles S have an embossed tipping paper T wrapped around their filter plugs so that the bands of plain regions formed substantially in the middle of the embossed tipping paper T align with the stage of the manufacturing system 10 used to form the ventilation holes. Specifically, the embossed tipping paper T wrapped around the filter plugs of the smoking articles of FIG. 5 may have been manufactured using an embossing roller 4 as shown in conjunction with FIG. 10. In FIG. 5, the ventilation hole forming stage is shown as a laser cutting device 3 that focuses a laser beam onto the surface of the tipping paper T. The laser beam forms ventilation holes V into the embossed tipping paper T of semi-manufactured smoking articles S that are rotated in the transportation grooves of the perforation drum 1 with the aid of the tension rollers 2.

FIG. 9 illustrates an exemplary flow diagram of a method M for manufacturing a smoking article with embossed tipping paper. The method M may in particular be performed using a manufacturing system 10 as described and explained in conjunction with FIGS. 4 and 5. The method M may further be executed in order to obtain a smoking article S as shown in FIG. 1, the smoking article S having embossed tipping paper according to any of the FIG. 2, 3, 6, 7 or 8.

In a first step M1, a patterned embossing structure is formed in the depth of the material of the tipping paper T to form a relief pattern region R. In a second step M2, at least one plain region adjacent to the relief pattern region R is omitted during formation of the patterned embossing structure in the depth of the material of the tipping paper T. That way the tipping paper T, after embossing, includes a relief pattern region R with a patterned embossing structure and at least one plain region not having a patterned embossing structure. The embossing operation is performed on tipping paper T having a substantially rectangular shape such that at least one plain region forms a band of fixed width running between two parallel edges of the substantially rectangular shape.

Optionally, a step M3 may involves forming a sequence of ventilation holes V in the at least one plain region of the tipping paper T, for example as a linear arrangement of a series of ventilation holes running in parallel to the band of fixed width in the middle of the at least one plain region. The forming of ventilation holes V may for example be performed using laser cutting.

Optionally, a step M4 may involve separating two portions of the embossed tipping paper T along the middle line of the band forming the at least one plain region. This may in particular include separating a double cigarette in two single cigarettes in the middle of the common filter plug. The separating cut is in this case set in a plain region in the middle of the tipping paper T.

In the foregoing detailed description, various features are grouped together in one or more examples or examples with the purpose of streamlining the disclosure. It is to be understood that the above description is intended to be illustrative, and not restrictive. It is intended to cover all alternatives, modifications and equivalents. Many other examples will be apparent to one skilled in the art upon reviewing the above specification.

1. An embossed tipping paper for use in smoking articles, the tipping paper comprising:
a relief pattern region having a patterned embossing structure formed in a depth of a material of the tipping paper; and
at least one plain region adjacent to the relief pattern region, the at least one plain region not having an embossing structure formed in the depth of the material of the tipping paper, and a sequence of ventilation holes being formed in the at least one plain region,
wherein the embossed tipping paper has a substantially rectangular shape, the at least one plain region forming a band of fixed width running between two parallel edges of the substantially rectangular shape.

2. The embossed tipping paper according to claim 1, wherein the fixed width of the at least one plain region is at least 1 mm.

3. The embossed tipping paper according to claim 1, wherein the at least one plain region comprises at least two plain regions adjacent to the relief pattern region, the at least two plain regions not having an embossing structure formed in the depth of the material of the tipping paper, and running in parallel to each other between the two parallel edges of the substantially rectangular shape of the embossed tipping paper.

4. The embossed tipping paper according to claim 3, wherein a first of the at least two plain regions is formed substantially at a side edge of the two parallel edges of the substantially rectangular shape of the embossed tipping paper.

5. The embossed tipping paper according to claim 3, wherein both of the at least two plain regions are formed substantially in the middle of the substantially rectangular shape of the embossed tipping paper.

6. The embossed tipping paper according to claim 4, wherein a second of the at least two plain regions is formed substantially in the middle of the substantially rectangular shape of the embossed tipping paper.

7. The embossed tipping paper according to claim 1, wherein the patterned embossing structure is formed to a depth of more than 45 μm of the material of the tipping paper.

8. The embossed tipping paper according to claim 1, wherein the sequence of ventilation holes is a linear arrangement of a series of ventilation holes running in parallel to the band of fixed width in the middle of the at least one plain region.

9. A smoking article, particularly a cigarette, a double cigarette, a cigarette cartridge, a disposable tobacco stick or a double disposable tobacco stick, comprising a filter plug and the embossed tipping paper according to claim 1, the embossed tipping paper being wrapped around the filter plug.

10. The smoking article according to claim 9, further comprising a plug wrap made from porous paper wrapped around the filter plug beneath the embossed tipping paper.

11. The smoking article according to claim 10, wherein the embossed tipping paper has a higher basis weight than a basis weight of the paper of the plug wrap.

12. An embossing roller used for embossing tipping paper for smoking articles, the embossing roller comprising:
an engraving pattern on a roller surface, the engraving pattern configured to form a relief pattern region having a patterned embossing structure in a depth of a material of the tipping paper; and
at least one plain area on the roller surface adjacent to the engraving pattern, the at least one plain area configured to form at least one plain region adjacent to the relief pattern region, the at least one plain region not having an embossing structure formed in the depth of the material of the tipping paper,
wherein the at least one plain area forms a band of fixed width running through the engraving pattern in parallel to a circumference of the embossing roller.

13. A manufacturing system for manufacturing smoking articles with embossed tipping paper, the manufacturing system comprising at least one of the embossing roller according to claim 12.

14. The manufacturing system according to claim 13, further comprising:
a laser cutting device configured to form ventilation holes into the embossed tipping paper wrapped around a filter plug of semi-manufactured smoking articles running through the manufacturing system, the a-laser cutting device being configured to form a sequence of ventilation holes in the at least one plain region of the tipping paper.

15. A method of manufacturing smoking articles with embossed tipping paper, comprising the steps of:
forming a patterned embossing structure in a depth of a material of the tipping paper to form a relief pattern region;
omitting at least one plain region adjacent to the relief pattern region during formation of the patterned embossing structure in the depth of the material of the tipping paper, so that the tipping paper includes the relief pattern region with the patterned embossing structure and the at least one plain region not having a patterned embossing structure; and
forming a sequence of ventilation holes in the at least one plain region of the tipping paper,
wherein the embossed tipping paper has a substantially rectangular shape, the at least one plain region forming a band of fixed width running between two parallel edges of the substantially rectangular shape.

16. The method according to claim 15, wherein the sequence of ventilation holes is formed as a linear arrangement of a series of ventilation holes running in parallel to the band of fixed width in the middle of the at least one plain region.

17. The method according to claim 15, wherein forming the sequence of ventilation holes is performed using laser cutting.

18. The method according to claim 15, further comprising:
separating two portions of the embossed tipping paper along a middle line of the band forming the at least one plain region.
